(19) United States
(12) Patent Application Publication
(10) Pub. No.: US 2013/0236101 A1
(43) Pub. Date: Sep. 12, 2013

(54) INFORMATION PROCESSING APPARATUS, NON-TRANSITORY COMPUTER READABLE MEDIUM, AND INFORMATION PROCESSING METHOD

(71) Applicants: Hitoshi OKAMOTO, Kanagawa (JP); Tetsuya KIMURA, Kanagawa (JP); Kengo SHINOZAKI, Kanagawa (JP); Akira SEKINE, Kanagawa (JP); Tohru HISANO, Kanagawa (JP); Atsushi HIRANO, Kanagawa (JP)

(72) Inventors: Hitoshi OKAMOTO, Kanagawa (JP); Tetsuya KIMURA, Kanagawa (JP); Kengo SHINOZAKI, Kanagawa (JP); Akira SEKINE, Kanagawa (JP); Tohru HISANO, Kanagawa (JP); Atsushi HIRANO, Kanagawa (JP)

(73) Assignee: FUJI XEROX CO., LTD., Tokyo (JP)

(21) Appl. No.: 13/610,141

(22) Filed: Sep. 11, 2012

(30) Foreign Application Priority Data
Mar. 8, 2012 (JP) 2012-051310

(51) Int. Cl. G06K 9/46

(52) U.S. Cl. 382/190

(57) ABSTRACT

An information processing apparatus includes an image receiving unit receiving an image including an information image which is an image indicating information, an extraction unit extracting image identification information for identifying the image and a position in the image from the information image in the image received by the image receiving unit, a correlation unit correlating operator identification information for identifying an operator performing an operation with the image identification information and the position in the image extracted by the extraction unit, an output unit outputting a result of the correlation by the correlation unit, and a presentation unit extracting operator identification information corresponding to the image identification information and the position in the image extracted by the extraction unit from a memory which stores information output by the output unit, and presenting a symbol indicating an operator on the image on the basis of the operator identification information.

### CROSS-REFERENCE TO RELATED APPLICATIONS

This application is based on and claims priority under 35 USC 119 from Japanese Patent Application No. 2012-051310 filed Mar. 8, 2012.

### BACKGROUND

### Technical Field

The present invention relates to an information processing apparatus, a non-transitory computer readable medium, and an information processing method.

### SUMMARY

According to an aspect of the invention, there is provided an information processing apparatus including an image receiving unit that receives an image including an information image which is an image indicating information; an extraction unit that extracts image identification information for identifying the image and a position in the image from the information image in the image received by the image receiving unit; a correlation unit that correlates operator identification information for identifying an operator performing an operation with the image identification information and the position in the image extracted by the extraction unit; an output unit that outputs a result of the correlation by the correlation unit; and a presentation unit that extracts operator identification information corresponding to the image identification information and the position in the image extracted by the extraction unit from a memory which stores information output by the output unit, and presents a symbol indicating an operator on the image on the basis of the operator identification information.

### BRIEF DESCRIPTION OF THE DRAWINGS

Exemplary embodiments of the present invention will be described in detail based on the following figures, wherein:

FIG. 1 is a conceptual module configuration diagram regarding a configuration example of the exemplary embodiment (registration information processing apparatus);

FIG. 2 is a flowchart illustrating a process example performed by the exemplary embodiment (registration information processing apparatus);

FIG. 3 is a conceptual module configuration diagram regarding a configuration example of the exemplary embodiment (related content managing apparatus);

FIG. 4 is a flowchart illustrating a process example performed by the exemplary embodiment (related content managing apparatus);

FIG. 5 is a diagram illustrating a data structure example of the content correlation table;

FIG. 6 is a flowchart illustrating a process example performed by the exemplary embodiment (related content managing apparatus);

FIG. 7 is a conceptual module configuration diagram regarding a configuration example of the exemplary embodiment (presentation information processing apparatus);

FIG. 8 is a flowchart illustrating a process example performed by the exemplary embodiment (presentation information processing apparatus);

FIG. 9 is a diagram illustrating a data structure example of the user management table;

FIG. 10 is a diagram illustrating a data structure example of the display method management table;

FIG. 11 is a diagram illustrating a system configuration example when the exemplary embodiment is realized;

FIGS. 12A to 12C are diagrams illustrating an example of the information image;

FIG. 13 is a diagram illustrating an example of using the exemplary embodiment;

FIG. 14 is a diagram illustrating a process example performed by the exemplary embodiment (registration information processing apparatus);

FIGS. 15A and 15B are diagrams illustrating a process example performed by the exemplary embodiment (presentation information processing apparatus);

FIG. 16 is a diagram illustrating a process example performed by the exemplary embodiment (presentation information processing apparatus);

FIG. 17 is a diagram illustrating a process example performed by the exemplary embodiment (presentation information processing apparatus);

FIG. 18 is a block diagram illustrating a computer hardware configuration example for realizing the exemplary embodiments (the registration information processing apparatus and the related content managing apparatus); and

FIG. 19 is a block diagram illustrating a computer hardware configuration example for realizing the exemplary embodiments (the presentation information processing apparatus).

### DETAILED DESCRIPTION

Hereinafter, exemplary embodiments for implementing the invention will be described with reference to the drawings.

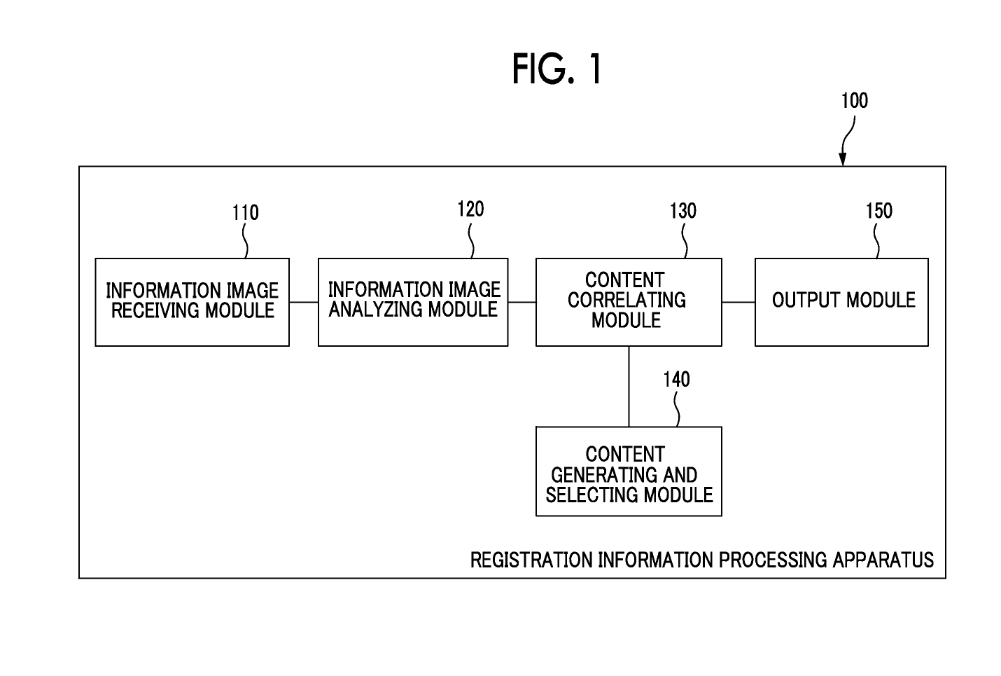

FIG. 1 is a conceptual module configuration diagram regarding a configuration example of the exemplary embodiment (registration information processing apparatus 100).

In addition, the module indicates components such as software (computer program) and hardware which may be generally and logically divided. Therefore, the module in the exemplary embodiment indicates not only a module in a computer program but also a module in a hardware configuration. Accordingly, the exemplary embodiment also includes description of a computer program for causing a computer to function as the module (a program for causing a computer to execute the respective procedures, a program for causing a computer to function as the respective units, or a program for causing a computer to realize the respective functions), a system, and a method. For convenience of the description, although the term “store”, or “make store”, and terms equivalent to it are used, these terms mean that, in a case of a computer program, it is stored in a storage device or is controlled so as to be stored in the storage device. In addition, the module may correspond to a function one to one. In a case of mounting, a single module may be configured by a single program, plural modules may be configured by a single program, or conversely a single module may be configured by plural programs. In addition, plural modules may be executed by a single computer, or a single module may be executed by plural computers using computers in distributed or parallel environments. Further, other modules may be included in a single module. Hereinafter, the term “connection” is used not only in a case of physical connection but also in a case of logical connection (data transmission and reception, instruction, reference relationship between data, and the like). The term “predefined” indicates being defined before a process which is a target, and is used to include a meaning of being defined according to circumstances or states at that time or according to circumstances or states hitherto as long as the process which is a target is not performed, even after a process according to the exemplary embodiment starts including a state where the process according to the exemplary embodiment does not start. In a case where there are plural “predefined values”, the values may be different, or two or more values (of course, including all the values) may be the same. Further, the phrase having a meaning that “in a case of A, B is performed” is used as a meaning that “whether or not there is A is determined, if it is determined that there is A, B is performed”. However, a case where determination regarding whether or not there is A is unnecessary is excluded.

In addition, the system or the apparatus includes not only a case where plural computers, plural pieces of hardware, plural apparatuses, and the like are configured to be connected to each other via communication unit such as a network (including communication connection of one-to-one correspondence) but also a case where it is realized by a single computer, a piece of hardware, a single apparatus, and the like. The “apparatus” and the “system” are used as terms having the same meaning. Of course, the “system” does not include social “structures” (social systems) which are merely artificial arrangements.

In addition, for each process performed by each module, or for each process in a case where plural processes are performed in a module, information which is a target is read from a storage device, the process is performed, and then the process result is written in the storage device. Therefore, there are cases where description of reading from the storage device before the process and writing in the storage device after the process may be omitted. The storage device here may include a hard disk, a Random Access Memory (RAM), an external storage medium, a storage device via a communication line, a register in a Central Processing Unit (CPU), or the like.

A registration information processing apparatus 100 according to the exemplary embodiment correlates an operator identification information (hereinafter, referred to as an operator ID (IDentification)) with an image including an information image on the basis of an operation of the operator, and includes, as shown in the example of FIG. 1, an information image receiving module 110, an information image analyzing module 120, a content correlating module 130, a content generating and selecting module 140, and an output module 150. In addition, electronic information (there are a still image, a moving image, sound, a text, and the like, which are hereinafter, referred to as content items) may be correlated based on an operation of an operator. Further, operator identification information of an operator performing the correlation may be correlated.

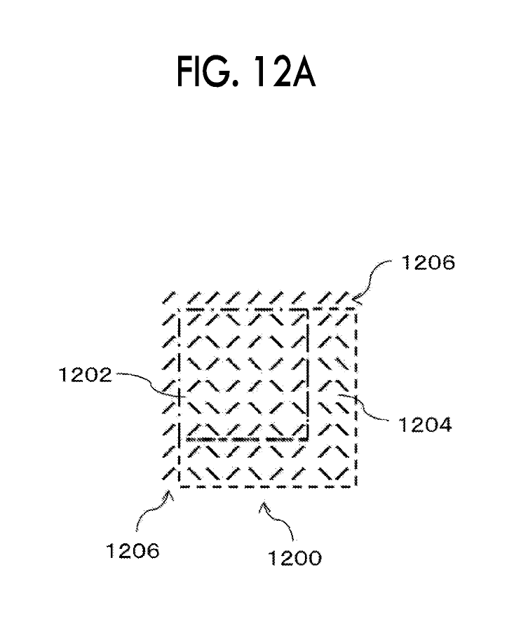

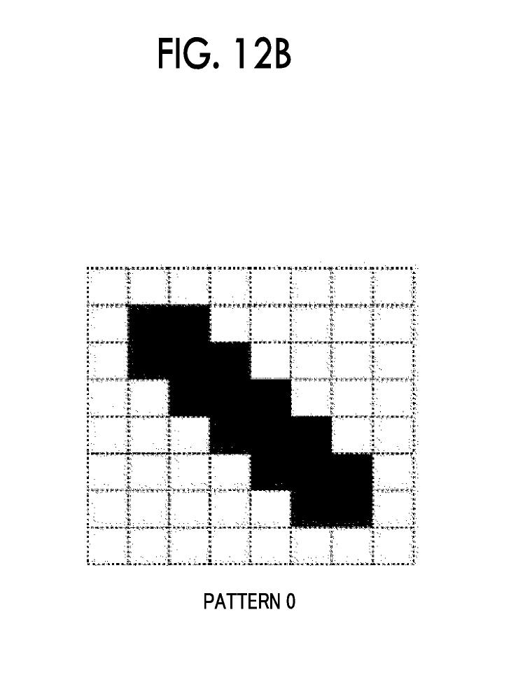

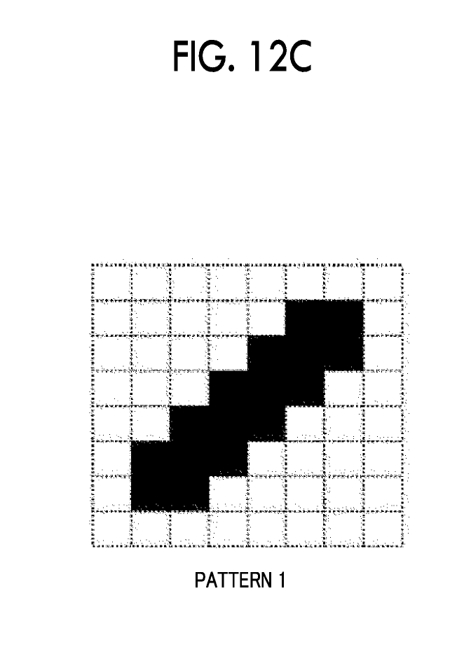

In addition, the information image refers to an image code which is systematically created in order to indicate electronic data in a machine readable manner, and a detailed example thereof will be described later with reference to FIGS. 12A to 12C.

The information image receiving module 110 is connected to the information image analyzing module 120. The information image receiving module 110 receives an image including an information image which is an image indicating information. In addition, the information image may be printed on the entire surface of the received image or on a predefined region thereof. For example, the predefined region is a region which is scheduled to be correlated with electronic information. Here, the reception of an image includes, for example, reading an image with a scanner, a camera (including an infrared camera), or the like, receiving an image with a facsimile or the like from an external apparatus via a communication line, reading an image stored in a hard disk (embedded in a computer but including other hard disks or the like connected via a network), and the like. The image may be a binary image or a multi-value image (including a color image). A single image or plural images may be received. In addition, a content of the image may be a document used for business, a pamphlet for advertising, or the like.

For example, the image corresponds to a portion of a document photographed by an operator. In addition, electronic information may be correlated with the photographed position.

The information image analyzing module 120 is connected to the information image receiving module 110 and the content correlating module 130. The information image analyzing module 120 extracts image identification information (hereinafter, referred to as a document ID) for identifying the image and a position in the image from the information image in the image received by the information image receiving module 110. At least the image identification information and the position in the image are buried in the information image.

In addition, the information image analyzing module 120 may extract a tilt of the information image in the image received by the information image receiving module 110. For example, as described later, a synchronous code image 1206 is included in the information image, and since the synchronous code image 1206 is horizontal or vertical, a tilt of the information image is detected using the tilt thereof.

The content generating and selecting module 140 is connected to the content correlating module 130. The content generating and selecting module 140 generates or selects electronic information correlated with a position (a position of the information image analyzed by the information image analyzing module 120) designated in the image on the basis of an operation of an operator. For example, a content item is generated (for example, character information is input) or a content item is selected (for example, image information is selected in an image database) through an operation of a mouse, a keyboard, a touch panel, or the like. The content correlating module 130 correlates the content item with the image. For example, a content item may be selected using a browser or the like.

In addition, a content item for correlating a moving image obtained by photographing a discussion hitherto (alternatively, sound information recording a discussion) may be used. Here, the “discussion hitherto” refers to a discussion performed until the content correlating module 130 performs the correlation. In addition, the discussion is a discussion regarding the image including the information image. This moving image is obtained by a video camera (or a microphone) photographing (or recording) a discussion performed by plural operators, and the moving image for which the correlation is performed is a moving image from the previous correlation to the present correlation.

The content correlating module 130 is connected to the information image analyzing module 120, the content generating and selecting module 140, and an output module 150. The content correlating module 130 correlates operator identification information for identifying an operator which performs an operation, with the image identification information and the position in the image extracted by the information image analyzing module 120. In addition, the operator may perform only an operation of the correlation without correlating the content item generated or selected by the content generating and selecting module 140. Specifically, a portion of an image captured by the operator is correlated. Of course, a portion of the captured image includes one or more information images.

The content correlating module 130 may further correlate the tilt extracted by the information image analyzing module 120.

The content correlating module 130 may further correlate the electronic information generated or selected by the content generating and selecting module 140.

In addition, although an example where the correlation process is performed after the content generating and selecting module 140 generates or selects a content item has been described, a content item may be correlated after a correlation process of a position and an operator ID is performed. In other words, the former is a case where a portion of an image is captured after a content item is generated or selected (relevant to identifying a position to be correlated), and the latter is a case where a content item is generated or selected after a portion of an image is captured.

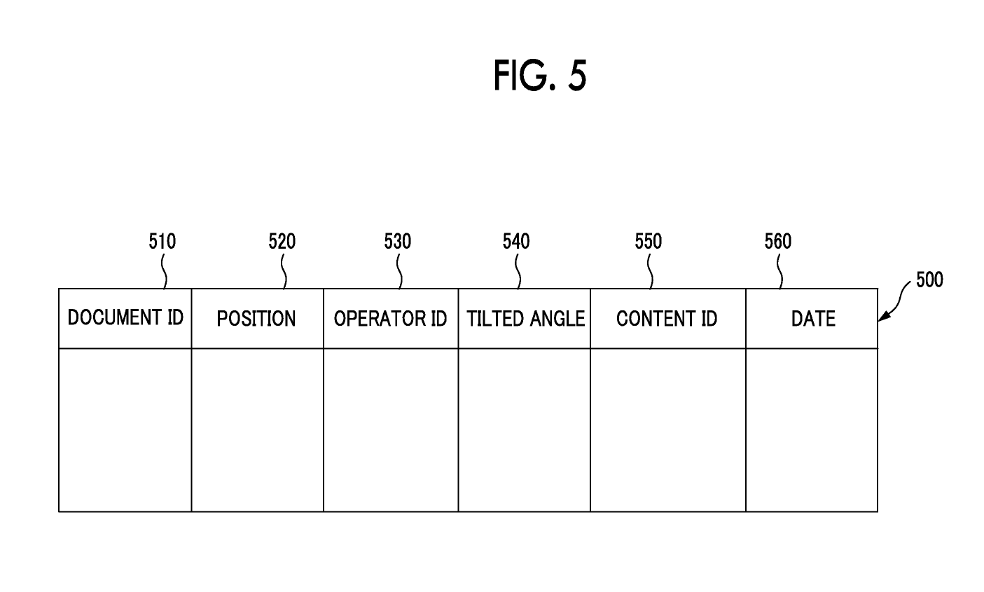

The content correlating module 130 generates, for example, a content correlation table 500 through the correlation process. FIG. 5 is a diagram illustrating a data structure example of the content correlation table 500. The content correlation table 500 includes a document ID column 510, a position column 520, an operator ID column 530, a tilted angle column 540, a content ID column 550, and a date column 560. The document ID column 510 stores image identification information (document ID) of a target image. The position column 520 stores a position (a position in an analysis result of the information image analyzing module 120) of an image received by the information image receiving module 110. The operator ID column 530 stores an operator ID of an operator (either a person performing photographing with the information image receiving module 110 or a person performing an operation with the content generating and selecting module 140, and, generally, the two are the same person). The tilted angle column 540 stores a tilted angle analyzed by the information image analyzing module 120. The content ID column 550 stores a content ID for identifying a content item generated or selected by the content generating and selecting module 140. The date column 560 stores the date (the year, the month, the day, the second, the second or less, or a combination thereof may be used) when the content correlating module 130 performs correlation.

The output module 150 is connected to the content correlating module 130. The output module 150 outputs a correlation result performed by the content correlating module 130. The output of the correlation result includes, for example, displaying the correlation result on a display devices such as a display, storing in a storage medium such as a memory card, sending to other information processing apparatuses, and the like. As the other information processing apparatuses, for example, there is a related content managing apparatus 300.

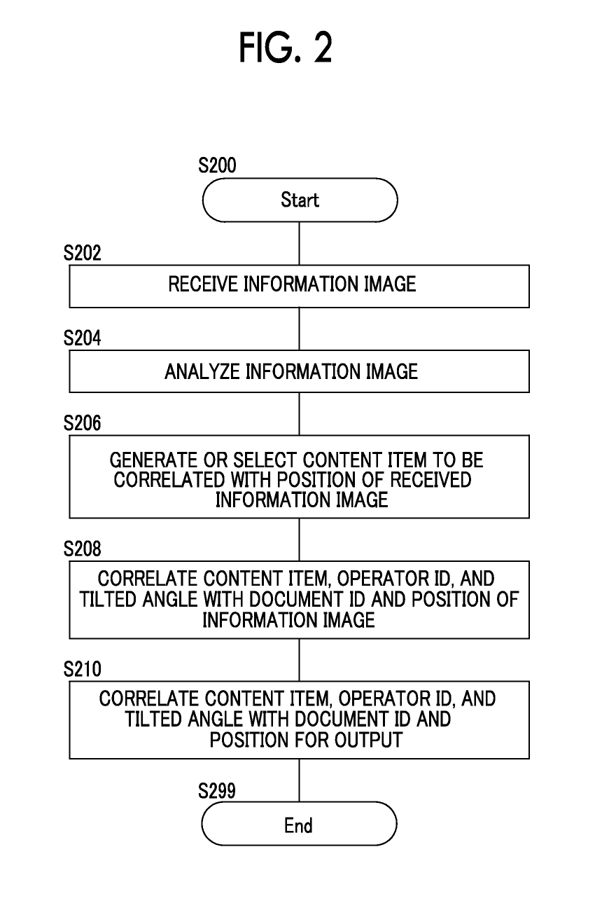

FIG. 2 is a flowchart illustrating a process example performed by the exemplary embodiment (the registration information processing apparatus 100).

In step S202, the information image receiving module 110 receives an information image.

In step S204, the information image analyzing module 120 analyzes the information image. Specifically, the information image analyzing module 120 extracts document identification information which may uniquely identify a document on which the information image is printed in the exemplary embodiment, a tilted angle of the information image, and a position of the information image, from the information image.

In step S206, the content generating and selecting module 140 generate or select a content item to be correlated with the position of the received information image.

In step S208, the content correlating module 130 correlates the content item, the operator ID, and the tilted angle with the document ID and the position of the information image.

In step S210, the output module 150 correlates the content item, the operator ID, and the tilted angle with the document ID and the position for output.

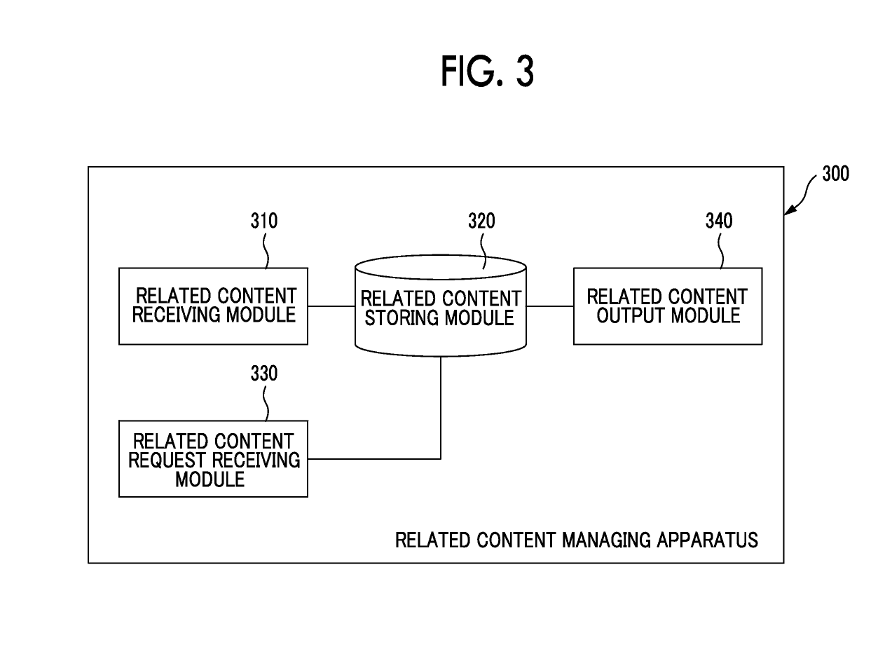

FIG. 3 is a conceptual module configuration diagram regarding a configuration example of the exemplary embodiment (related content managing apparatus 300). The related content managing apparatus 300 includes, as shown in the example of FIG. 3, a related content receiving module 310, a related content storing module 320, a related content request receiving module 330, and a related content output module 340.

The related content receiving module 310 is connected to the related content storing module 320. The related content receiving module 310 receives the correlation result output by the output module 150 of the registration information processing apparatus 100. For example, the content correlation table 500 is received. In addition, a correlation result may be received from each of plural registration information processing apparatuses 100 (for example, registration information processing apparatuses 100 which plural operators respectively have). Further, the related content receiving module 310 stores the correlation result in the related content storing module 320.

The related content storing module 320 is connected to the related content receiving module 310, the related content request receiving module 330, and the related content output module 340. The related content storing module 320 stores the correlation result received by the related content receiving module 310, and is accessed by the related content output module 340, and the like.

The related content request receiving module 330 is connected to the related content storing module 320. The related content request receiving module 330 receives a request from a related content extracting module 730 of a presentation information processing apparatus 700.

The related content output module 340 is connected to the related content storing module 320. The related content output module 340 extracts a correlation result corresponding to the request from the related content storing module 320 on the basis of the request received by the related content request receiving module 330, and transmits the extracted correlation result to the related content extracting module 730 of the presentation information processing apparatus 700.

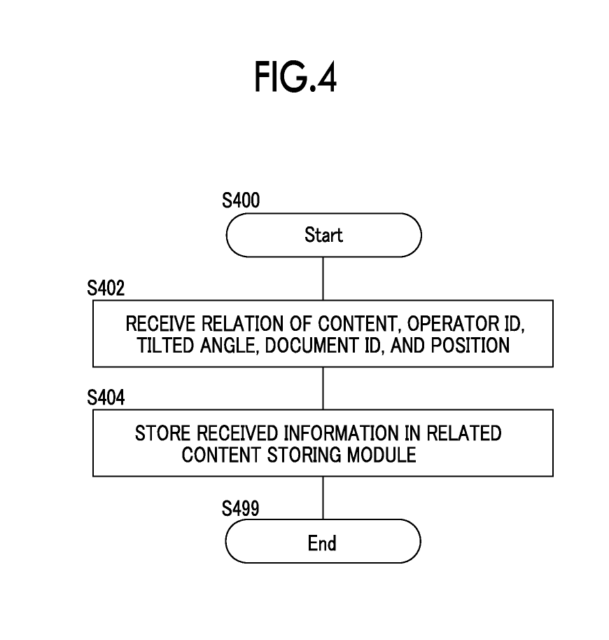

FIG. 4 is a flowchart illustrating a process example performed by the exemplary embodiment (the related content managing apparatus 300).

In step S402, the related content receiving module 310 receives relation of the content item, the operator ID, the tilted angle, the document ID, and the position.

In step S404, the related content receiving module 310 stores the received information in the related content storing module 320.

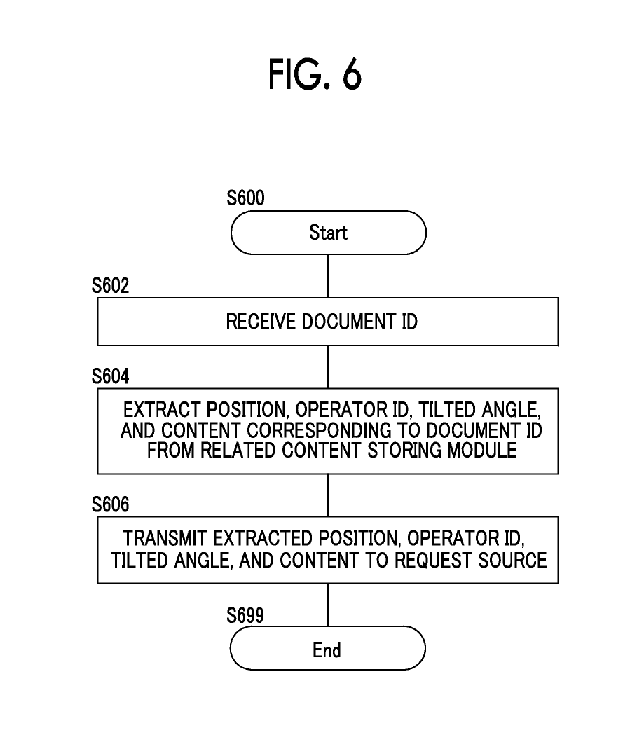

FIG. 6 is a flowchart illustrating a process example performed by the exemplary embodiment (the related content managing apparatus 300).

In step S602, the related content request receiving module 330 receives the document ID.

In step S604, the related content output module 340 extracts the position, the operator ID, the tilted angle, and the content item corresponding to the document ID from the related content storing module 320.

In step S606, the related content output module 340 transmits the extracted position, operator ID, tilted angle, and content item to the request source.

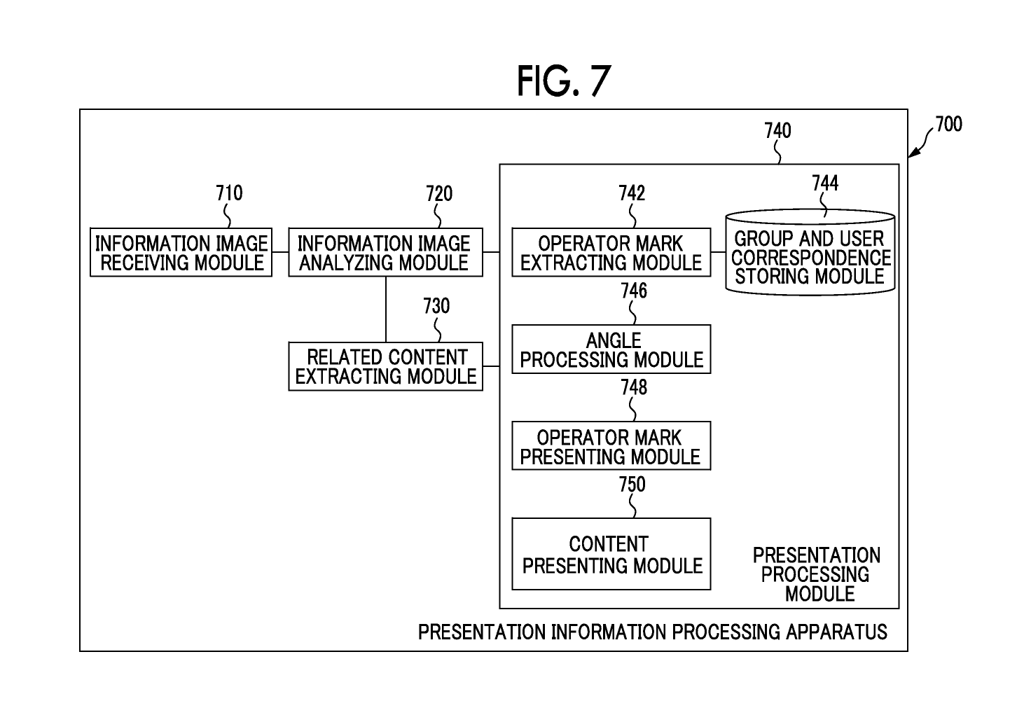

FIG. 7 is a conceptual module configuration diagram regarding a configuration example of the exemplary embodiment (the presentation information processing apparatus 700). The presentation information processing apparatus 700 includes, as shown in the example of FIG. 7, an information image receiving module 710, an information image analyzing module 720, a related content extracting module 730, and a presentation processing module 740.

The information image receiving module 710 is connected to the information image analyzing module 720. The information image receiving module 710 receives an image including an information image.

The information image analyzing module 720 is connected to the information image receiving module 710, the related content extracting module 730, and the presentation processing module 740. The information image analyzing module 720 extracts image identification information and a position in the image from the information image in the image received by the information image receiving module 710.

The related content extracting module 730 is connected to the information image analyzing module 720 and the presentation processing module 740. The related content extracting module 730 extracts an operator ID corresponding to the image identification information and the position in the image extracted by the information image analyzing module 720, from the related content storing module 320 (the related content storing module 320 which stores information output by the output module 150 of the registration information processing apparatus 100) which stores the operator ID for identifying an operator in correlation with the image identification information and the position in the image.

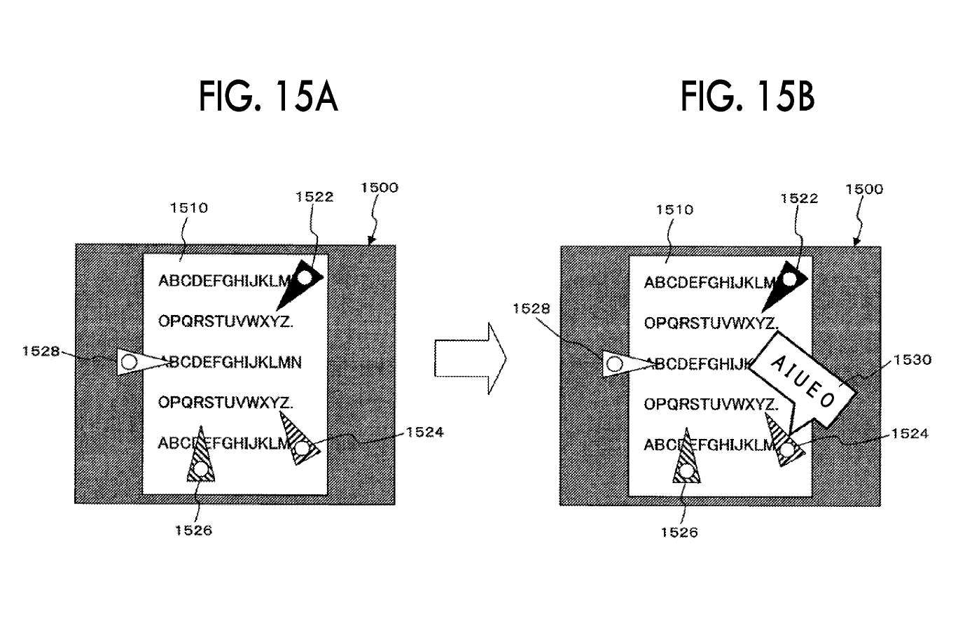

The presentation processing module 740 is connected to the information image analyzing module 720 and the related content extracting module 730. The presentation processing module 740 includes an operator mark extracting module 742, a group and user correspondence storing module 744, an angle processing module 746, an operator mark presenting module 748, and a content presenting module 750. The presentation processing module 740 presents a symbol indicating an operator on the basis of the operator ID extracted by the related content extracting module 730. For example, the symbol is presented as in an operator pin mark 1522 or the like in FIG. 15A described later.

In addition, the related content storing module 320 may further store correlation with a tilt of the information image of the image. The related content extracting module 730 may extract the tilt corresponding to the image identification information and the position in the image extracted by the information image analyzing module 720 from the related content storing module 320, and the presentation processing module 740 may present a symbol indicating an operator so as to be tilted on the basis of the tilt. For example, the symbol is presented so as to be tilted as in the operator pin mark 1522 or the like in FIG. 15A.

In addition, the related content storing module 320 may further store correlation with electronic information. The related content extracting module 730 may extract the electronic information and the tilt corresponding to the image identification information and the position in the image extracted by the information image analyzing module 720 from the related content storing module 320, and the presentation processing module 740 may present the electronic information so as to be tilted on the basis of the tilt. For example, the electronic information is presented so as to be tilted as in a related content item 1530 in FIG. 15B.

The operator mark extracting module 742 is connected to the group and user correspondence storing module 744. The operator mark extracting module 742 extracts a symbol (hereinafter, also referred to as an operator mark) corresponding to the operator from the group and user correspondence storing module 744. In addition, the operator ID of the operator here is an operator ID correlated with the position in the image by the related content extracting module 730. In other words, the operator ID is an operator ID extracted by the related content extracting module 730.

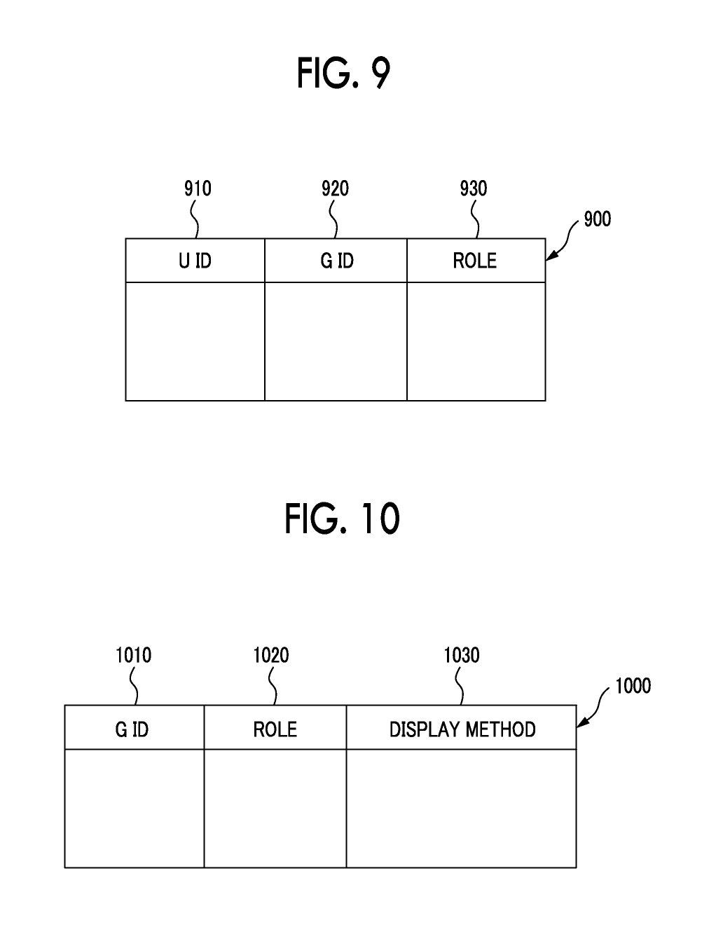

The group and user correspondence storing module 744 is connected to the operator mark extracting module 742. The group and user correspondence storing module 744 stores, for example, a user management table 900, and a display method management table 1000. FIG. 9 is a diagram illustrating a data structure example of the user management table 900. The user management table 900 includes a UID column 910, a GID column 920, and a role column 930. The UID column 910 stores an operator ID. The GID column 920 stores a group ID which is information for identifying a group (the group may include an organization) to which an operator of the operator ID belongs. The role column 930 stores information (hereinafter, also referred to as role information) indicating a role (for example, a leader, a general group member, or the like) of the operator of the operator ID in the group.

FIG. 10 is a diagram illustrating a data structure example of the display method management table 1000. The display method management table 1000 includes a GID column 1010, a role column 1020, and a display method column 1030. The GID column 1010 stores a group ID. The role column 1020 stores role information in a group of the group ID. The display method column 1030 stores a symbol indicating an operator having the role in the group. A different symbol may be displayed for each role. In addition, a different symbol may be displayed for each operator by giving a separate role to each operator.

The angle processing module 746 tilts the symbol corresponding to the operator extracted by the operator mark extracting module 742 on the basis of the tilt extracted by the related content extracting module 730. In addition, the angle processing module 746 tilts the electronic information extracted by the related content extracting module 730 on the basis of the tilt extracted by the related content extracting module 730. The tilt process may perform so-called affine transform for an image which is a tilt target.

The operator mark presenting module 748 presents the symbol, corresponding to the operator and tilted by the angle processing module 746.

The content presenting module 750 presents the electronic information tilted by the angle processing module 746. In addition, a presentation destination is a display device such as a liquid crystal display provided in the presentation information processing apparatus 700. Further, the symbol and the electronic information corresponding to the operator are presented so as to correspond to the correlated position on the image.

The registration information processing apparatus 100 and the presentation information processing apparatus 700 may be combined. In this case, either a combination of the information image receiving module 110 and the information image analyzing module 120 or a combination of the information image receiving module 710 and the information image analyzing module 720 may be used.

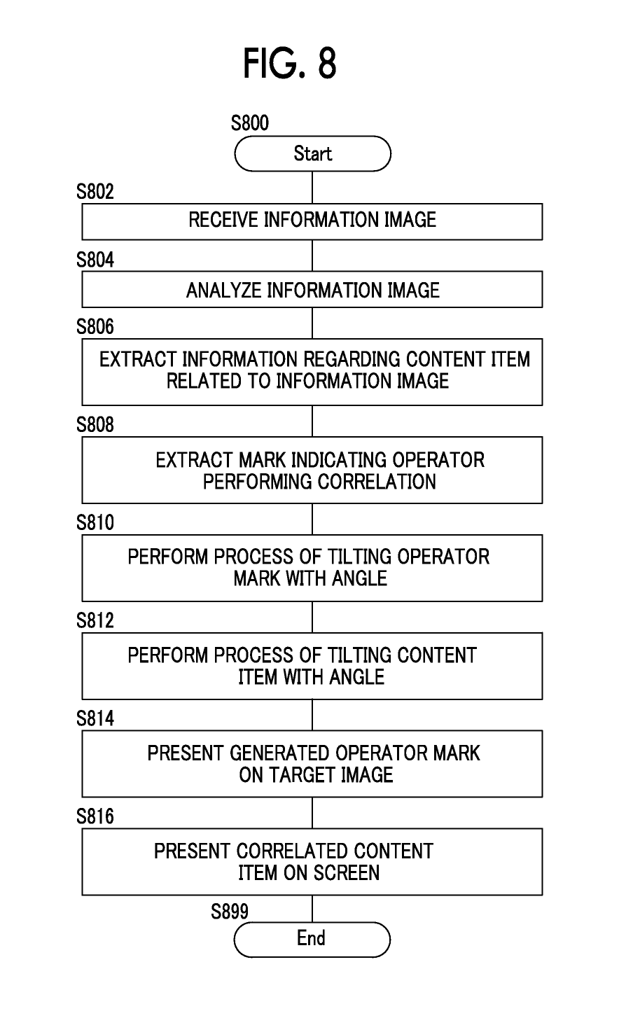

FIG. 8 is a flowchart illustrating a process example performed by the exemplary embodiment (the presentation information processing apparatus 700).

In step S802, the information image receiving module 710 receives an information image.

In step S804, the information image analyzing module 720 analyzes the information image.

In step S806, the related content extracting module 730 extracts information regarding content item related to the information image.

In step S808, the operator mark extracting module 742 extracts a mark indicating an operator performing correlation.

In step S810, the angle processing module 746 performs a process of tilting the operator mark with an angle.

In step S812, a process of tilting the content item with an angle is performed.

In step S814, the operator mark presenting module 748 presents the generated operator mark on a target image.

In step S816, the content presenting module 750 presents the correlated content item on a screen.

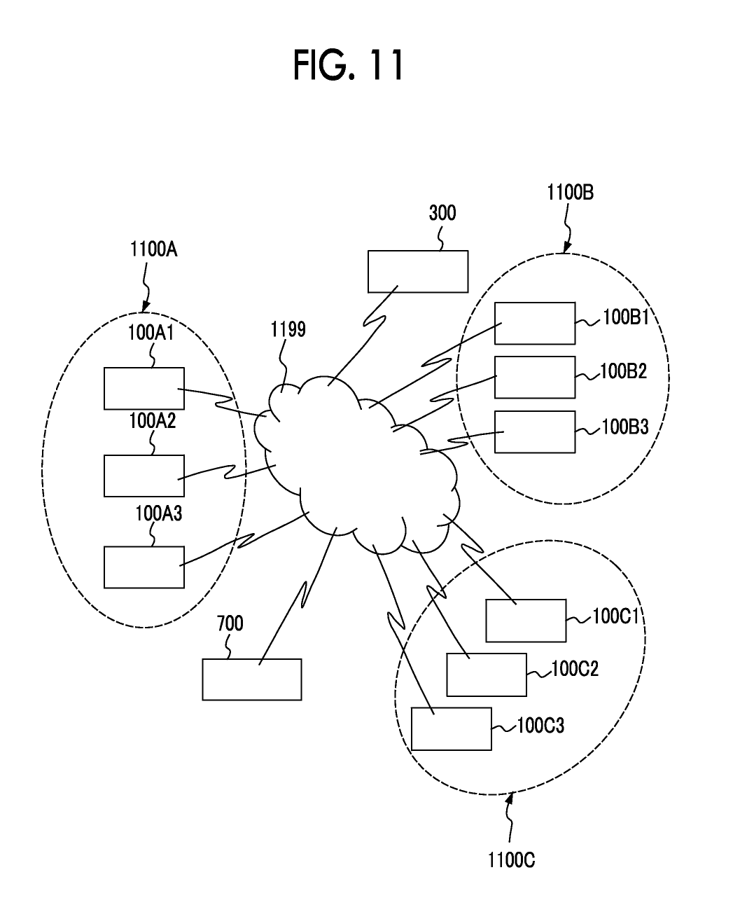

FIG. 11 is a diagram illustrating a system configuration example when the exemplary embodiment is realized.

The registration information processing apparatus 100A1 and the like, the registration information processing apparatus 100B1 and the like, the registration information processing apparatus 100C1 and the like, the related content managing apparatus 300, and the presentation information processing apparatus 700 are connected to each other via a communication line 1199. Each of the registration information processing apparatus 100A1 and the like, the registration information processing apparatus 100B1 and the like, the registration information processing apparatus 100C1 and the like corresponds to the registration information processing apparatus 100 exemplified in FIG. 1. Therefore, content items are correlated with positions of images through operations of operators of the registration information processing apparatus 100A1 and the like, the registration information processing apparatus 100B1 and the like, the registration information processing apparatus 100C1 and the like, the correlation results are stored in the related content managing apparatus 300, and content items correlated with the positions are presented by the presentation information processing apparatus 700. In addition, the registration information processing apparatus 100A1, the registration information processing apparatus 100A2, and the registration information processing apparatus 100A3 form a group A terminal group 1100A, the registration information processing apparatus 100B1, the registration information processing apparatus 100B2, and the registration information processing apparatus 100B3 form a group B terminal group 1100B, and the registration information processing apparatus 100C1, the registration information processing apparatus 100C2, and the registration information processing apparatus 100C3 form a group C terminal group 1100C. In addition, images corresponding to the correlation results of the respective groups are presented. Specifically, the presentation information processing apparatus 700 presents content items correlated by the group A terminal group 1100A on a single image. In this case, content items correlated by the other group B terminal group 1100B and group C terminal group 1100C are not presented on the image. In addition, in a case where content items correlated by the group B terminal group 1100B are presented on an image, content items correlated by the other group A terminal group 1100A and group C terminal group 1100C are not presented on the image.

FIGS. 12A to 12C are diagrams illustrating an example of the information image.

This example is a two-dimensional code pattern image which uses a glyph code (for example, JP-A-6-103390 and JP-A-6-75795), developed in the Palo Alto Research Center of Xerox Company of U.S.A. and expressing data with diagonal lines having different angles, as a code symbol which is an information image.

In this example, a unit region 1200 is a square region of 8-symbol×8-symbol. A value of each symbol is expressed by a diagonal line pattern as shown in FIGS. 12B and 12C. In this example, a symbol value 0 is expressed by a diagonal line (pattern 0 in the example of FIG. 12B) from upper left to lower right, forming 45 degrees with respect to the vertical line in the counterclockwise direction, and a symbol value 1 is expressed by a diagonal line (pattern 1 in the example of FIG. 12C) from lower left to upper right, forming 45 degrees with respect to the vertical line in the clockwise direction.

Of them, a position code image 1202 is a square image of 6-symbol×6-symbol in the upper left corner of the unit region 1200, and an identification code image 1204 is a reverse L-shaped image which is obtained by excluding the square of 6×6 symbols from the unit region 1200.

In addition, in this example, a column and a row of the synchronous code image 1206 are provided in each direction of the vertical and horizontal directions along the outer circumference of the unit region 1200. In this example, the synchronous code image 1206 is a continuity of the diagonal line symbol from lower left to upper right (“1”), and a size and an arrangement pitch of the symbol is the same as the symbol size and pitch in the unit region 1200. The synchronous code image 1206 is vertically and horizontally provided at an equal interval, and each unit region 1200 is provided at a square region surrounded by the synchronous code images 1206. The synchronous code images 1206 indicate an end of each unit region 1200. In other words, when a device which reads the two-dimensional code pattern detects a column and a row where the symbol from lower left to upper right is continuously located, the inside of the lattice mesh formed by the column and row may be recognized as the unit region 1200, and 6×6 symbols at the upper left corner of the unit region 1200 may be recognized as the position code image 1202.

In addition, the synchronous code image 1206 may not be one exemplified in FIGS. 12A to 12C as long as a location of the unit region 1200 or the position code image 1202 may be specified. For example, an arrangement of a symbol with a specific shape different from the diagonal line symbol at four corners of the unit region 1200 may be the synchronous code image 1206. Although, in the example shown in FIGS. 12A to 12C, the column and the row of the width corresponding to a single symbol are used for the synchronous code image 1206, if a mark forming the synchronous code image 1206 is sufficiently small, the unit regions 1200 may be arranged in a two-dimensional manner without a gap, and the mark may be disposed in a blank space between the adjacent unit regions 1200.

In the example shown in FIGS. 12A to 12C, a total of 36 symbols, that is, data of 36 bits are stored in a single position code image 1202. Of 36 bits, 18 bits may be used for encoding of x coordinates, and 18 bits may be used for encoding of y coordinates. If 18 bits are used for encoding of positions, 2̂18 (about 260,000) positions may be encoded. In a case where each diagonal line pattern is constituted by 8-pixel×8-pixel as shown in the example of FIGS. 12B and 12C, printing is performed at 600 dpi (dots per inch), the length in each of the vertical and horizontal directions of one dot of 600 dpi is 0.0423 mm, and thus the length of each of the vertical and horizontal directions of the two-dimensional code of FIGS. 12A to 12C (including the synchronous code image 1206) is approximately 3 mm (=8 pixels per symbol×9 symbols×0.0423 mm) in both the vertical and horizontal directions. In a case where 260,000 positions are encoded at the interval of 3 mm, the length of approximately 786 m may be encoded. Although all of 18 bits are used for encoding of positions if reading accuracy is favorable, redundant bits for error detection or error correction may be included in a case where reading errors are problematic. If a ratio of the redundant bits taking up 18 bits is increased, a performance of error detection or error correction is improved, but a position range capable of being expressed is reduced.

In addition, in the example of FIGS. 12A to 12C, the identification code image 1204 is disposed in the rectangular region of 2-bit×8-bit and the rectangular region of 2-bit×6-bit, and thus may store identification information of a total of 28 bits. In a case where 28 bits are used as identification information or the like, approximately two hundred seventy million (2̂28) pieces of identification information may be expressed; however, some of 28 bits may be used as redundant bits for error detection or error correction so as to cope with reading errors. In addition, the identification information or the like includes at least first written information or second written information, and may include other document ID, page ID, and the like. For example, a paper identification number or the like for uniquely identifying paper may be included. The identification code images 1204 in the unit regions 1200 printed in a writing column of a piece of paper are the same. Of course, positional information indicated by the position code image 1202 in the unit region 1200 is information indicating a position in the paper, and thus the position code images 1202 in the respective unit region 1200 are different.

In the above example, 1-bit data is expressed by a single symbol by using two diagonal line patterns different by 90 degrees in an angle as a symbol; however, this is only an example. For example, if a pattern of a vertical line and a horizontal line is added to the symbol, 2-bit information may be expressed by a single symbol. As such, it is possible to increase the number of bits which may express a single symbol by increasing the kind of angle of a diagonal line pattern of the symbol. In addition, information images other than the glyph code may be used.

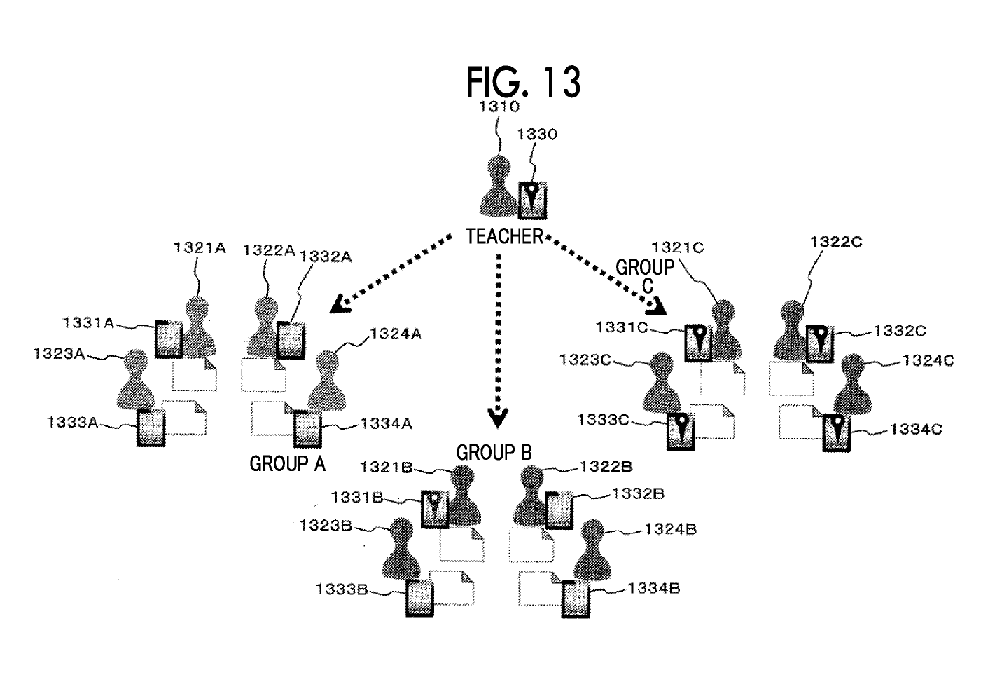

FIG. 13 is a diagram illustrating an example where the exemplary embodiment is used. A description will be made of an education scene in which a teacher 1310 gives an assignment (a document on which an information image is printed) to each group, and each group offers an answer to the assignment by correlating a content item (material) with the document.

When group discussion is performed, a teaching material (a document on which an information image is printed) and the registration information processing apparatus 100 (the registration information processing apparatus 1331A and the like, for example, which correspond to a camera, a touch panel, and a tablet type computer capable of generating or selecting a content item) for an individual are given. Content items collected by the individual in advance are stored in a server.

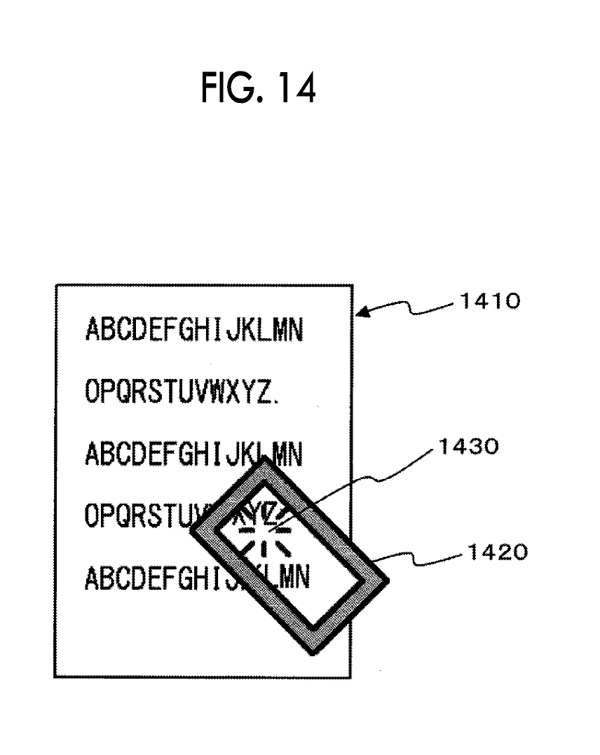

While performing the group discussion, a related material is correlated with each item of the teaching material using the registration information processing apparatus 1331A and the like. The correlation operation corresponds to photographing a portion of the teaching material using the cameras of the registration information processing apparatus 1331A and the like. FIG. 14 is a diagram illustrating a process example performed by the exemplary embodiment (the registration information processing apparatus 100). For example, a position (photographing position 1430) which is desired to be correlated is photographed in the teaching material 1410 on which an information image is printed using the registration information processing apparatus 1420 (the registration information processing apparatus 100, the registration information processing apparatus 1331A, or the like). After the correlation, a pin indicating who the information belongs to is displayed at the position on the screen. In addition, the teaching material is placed at the center of a table, and the correlation is performed at a position of each person (the user 1321A, the user 1322A, the user 1323A, the user 1324A, or the like). Therefore, when each person photographs a portion of the teaching material, the captured information image is tilted depending on a positional relationship between each person and the teaching material.

The correlated material may be also checked by a group member when the pin is opened via the registration information processing apparatus 1331A or the like. The discussion progresses while correlating content items (which may include comments, the journal, and the like (corresponding to the above-described “generated content items”)).

The correlation history or material of each group may be also viewed from the registration information processing apparatus 1330 of the teacher 1310. The teacher may correlate a content item (particularly, a comment or the like) with all the groups or some thereof as necessary.

In addition, in a place where a discussion result is announced, presentation is performed as in an example of FIGS. 15A and 15B by the presentation information processing apparatus 700. For example, the presentation may be performed using a projector. As shown in the example of FIG. 15A, a teaching material 1510 correlated with the content items is presented on a screen 1500, and operator pin marks 1522 to 1528 are presented on the teaching material 1510. Thereby, it is ascertained who has performed correlation (has spoken) at which position. In addition, if the operator pin mark 1524 is selected, as shown in the example of FIG. 15B, a related content item 1530 (a content item correlated with the position of the operator pin mark 1524) is presented. In addition, if the operator pin mark 1522 or the like is clicked, a thumbnail image or simple information of a content item may be displayed, and if double clicked, the content item may be opened and reproduced.

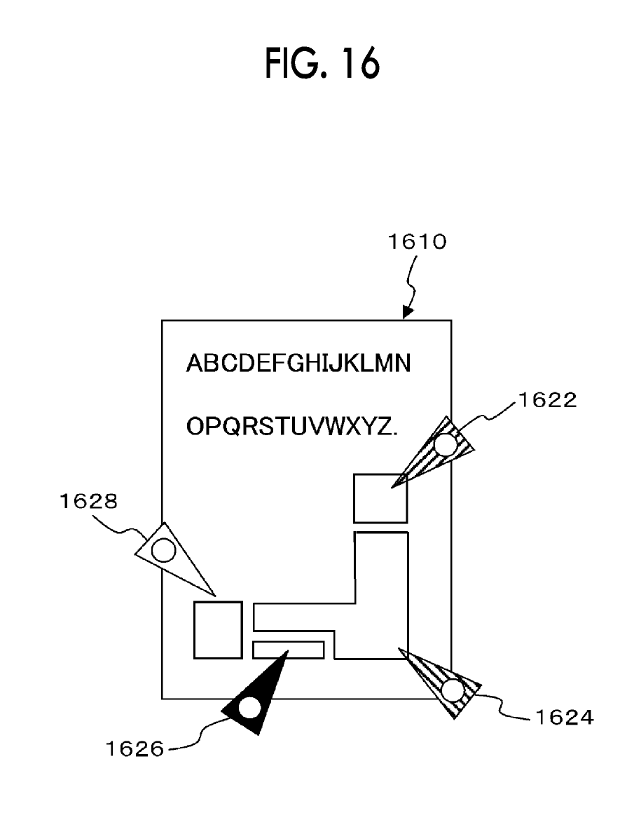

FIG. 16 is a diagram illustrating a process example (an example of registering a content item in a map) performed by the exemplary embodiment (the presentation information processing apparatus 700).

For example, in order to register a picture image content item in a map image 1610 using the registration information processing apparatus 100, the content item is correlated on the map image 1610 on the basis of a photographing point or a photographing direction.

In addition, the map image 1610 in which the content item is registered is managed by the presentation information processing apparatus 700. When the map image 1610 is displayed, operator pin marks 1622 to 1628 are displayed with angles of corresponding viewpoints at coordinates where the content items are registered.

For example, if the operator pin mark 1622 or the like is clicked, a thumbnail image or simple information of the content item may be displayed, and if double clicked, the content item may be opened and reproduced.

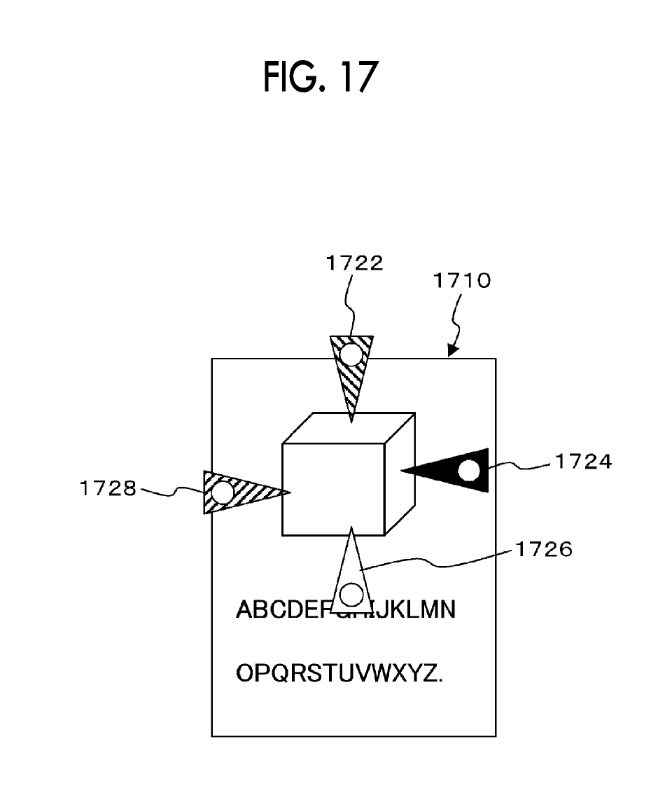

FIG. 17 is a diagram illustrating a process example (an example of registering a solid figure in a picture) performed by the exemplary embodiment (the presentation information processing apparatus 700).

For example, in order to register a content item in a solid figure document 1710 using the registration information processing apparatus 100, an image from a predefined viewpoint, a commentary at a predefined portion, or the like is correlated on the solid figure document 1710 so as to correspond to an orientation of the solid figure.

In addition, the solid figure document 1710 in which the content item is registered is managed by the presentation information processing apparatus 700. When the solid figure document 1710 is displayed, operator pin marks 1722 to 1728 are displayed with angles corresponding to the viewpoints or specific portions at the coordinates where the content items are registered.

For example, if the operator pin mark 1722 or the like is clicked, a thumbnail image or simple information of the content item may be displayed, and if double clicked, the content item may be opened and reproduced.

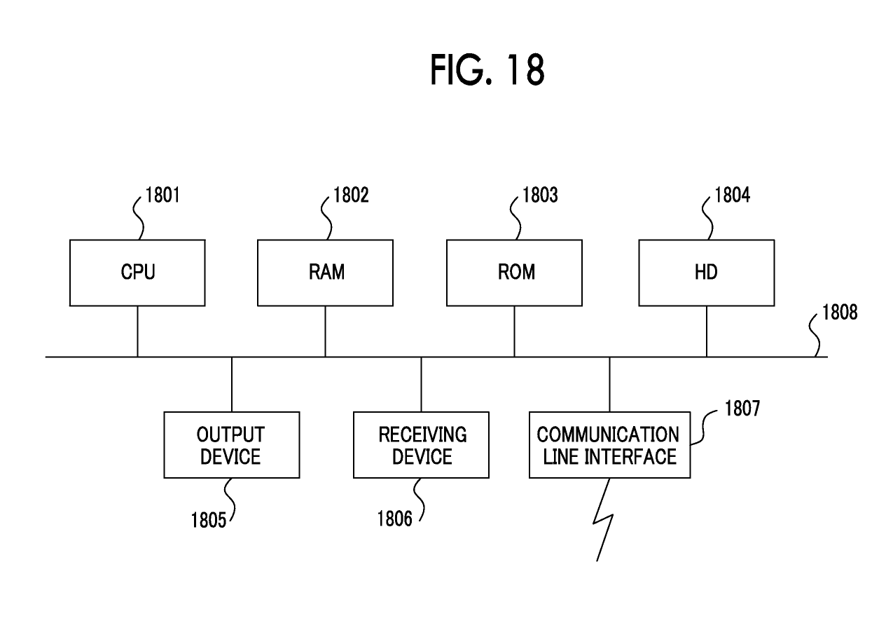

In addition, a hardware configuration of a computer executing a program as the exemplary embodiment (the registration information processing apparatus 100 or the related content managing apparatus 300) is a general computer as exemplified in FIG. 18, and, specifically, is a computer or the like which is a personal computer or a server. In other words, as a detailed example, a CPU 1801 is used as a processor (operation unit), and a RAM 1802, a ROM 1803, and an HD 1804 are used as storage devices. As the HD 1804, for example, a hard disk may be used. The exemplary embodiment is configured by the CPU 1801 which executes programs of the information image receiving module 110, the information image analyzing module 120, the content correlating module 130, the content generating and selecting module 140, the output module 150, the related content receiving module 310, the related content request receiving module 330, the related content output module 340, and the like, the RAM 1802 which stores the programs or data, the ROM 1803 which stores a program or the like for activating the computer, the HD 1804 which is an auxiliary storage device, a receiving device 1806 which receives image data by a camera, a scanner, or the like reading an image, or receives data on the basis of an operation of a user of a keyboard, a mouse, a touch panel, or the like, an output device 1805 such as a CRT, a liquid crystal display, or the like, a communication line interface 1807 such as a network interface card for connection to a communication network, and a bus 1808 for transmitting and receiving data between the above-described constituent elements. Plural computers may be connected to each other via a network.

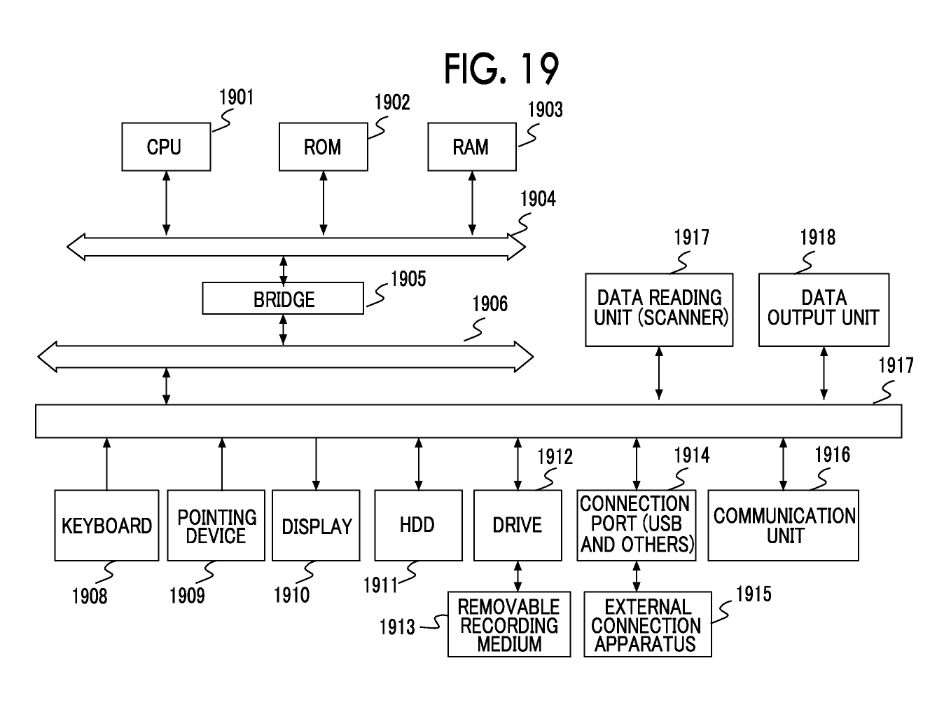

With reference to FIG. 19, a hardware configuration example of the exemplary embodiment (the presentation information processing apparatus 700) will be described. A configuration shown in FIG. 19 is implemented by, for example, a personal computer (PC) or the like, and is a hardware configuration example including a data reading unit 1917 such as a scanner and a data output unit 1918 such as a printer.

A Central Processing Unit (CPU) 1901 is a controller which executes processes according to a computer program which describes execution sequences of a variety of modules described in the above exemplary embodiment, that is, the information image receiving module 710, the information image analyzing module 720, the related content extracting module 730, the presentation processing module 740, the operator mark extracting module 742, the angle processing module 746, the operator mark presenting module 748, and the content presenting module 750.

A Read Only Memory (ROM) 1902 stores programs or operation parameters used by the CPU 1901. A Random Access Memory (RAM) 1903 stores programs used for execution of the CPU 1901 or parameters which are appropriately varied in the execution. They are connected to each other via a host bus 1904 constituted by a CPU bus.

The host bus 1904 is connected to an external bus 1906 such as a Peripheral Component Interconnect/Interface (PCI) bus via a bridge 1905.

A keyboard 1908 and a pointing device 1909 such as a mouse are input devices operated by an operator. A display 1910 includes a liquid crystal display, a projector, a Cathode Ray Tube (CRT), or the like, and displays a variety of information as text or image information.

A Hard Disk Drive (HDD) 1911 has a hard disk embedded therein, drives the hard disk, and records or reproduces a program or information executed by the CPU 1901. The hard disk stores content items, document images, the user management table 900, the display method management table 1000, and the like. In addition, a variety of computer programs such as various other data processing programs are stored therein.

A drive 1912 reads data or a program recorded on a removable recording medium 1913 such as a magnetic disk, an optical disc, a magneto-optical disc, or a semiconductor memory which is installed therein, and supplies the data and the program to the RAM 1903 which is connected thereto via the interface 1907, the external bus 1906, the bridge 1905, and the host bus 1904. The removable recording medium 1913 may be also used as a data recording region in the same manner as the hard disk.

A connection port 1914 is a port for connection to an external connection apparatus 1915 and has a connection unit such as a USB, or IEEE 1394. The connection port 1914 is connected to the CPU 1901 and the like via the interface 1907, the external bus 1906, the bridge 1905, and the host bus 1904. A communication unit 1916 is connected to a communication line and executes a data communication process with external apparatuses. The data reading unit 1917 is, for example, a scanner, and executes a document reading process. The data output unit 1918 is, for example, a printer, and executes a document data output process.

Among the above-described exemplary embodiments, the exemplary embodiments by a computer program are realized through cooperation of the software and hardware resources by reading the computer program which is software to the system of the hardware configuration exemplified in FIGS. 18 and 19.

In addition, the hardware configuration of the registration information processing apparatus 100, the related content managing apparatus 300, and the presentation information processing apparatus 700 shown in FIGS. 18 and 19 shows a configuration example, and the exemplary embodiment is not limited to the configuration shown in FIGS. 18 and 19 and may employ a configuration which may execute the modules described in the exemplary embodiment. For example, some modules may be constituted by dedicated hardware (for example, an application specific integrated circuit (ASIC)), some modules may have a form where they exist in an external system and are connected via a communication line, and plural systems shown in FIGS. 18 and 19 may be connected to each other via a communication line and be operated in cooperation with each other. In addition, the hardware configuration may be incorporated into a copier, a facsimile, a scanner, a multi-function peripheral (an image processing apparatus having two or more functions of the scanner, the printer, the copier and the facsimile), or the like.

In addition, the above-described program may be stored on a recording medium, or the program may be provided using a communication unit. In this case, for example, the above-described program may be understood as the invention of a “computer readable recording medium recording the program”.

The “computer readable recording medium recording the program” refers to a recording medium which is used to install and execute the program and distribute the program, records the program thereon and is capable of being read by a computer.

In addition, the recording medium includes, for example, “DVD-R, DVD-RW, DVD-RAM, or the like” which is a digital versatile disc (DVD) and is a standard formulated by the DVD forum, “DVD+R, DVD+RW, or the like” which is a standard formulated by DVD+RW, a read only memory (CD-ROM), a CD-recordable (CD-R), a CD-rewritable (CD-RW), or the like as a compact disc (CD), a Blu-ray disc (registered trademark), a magneto-optical disc (MO), a flexible disc (FD), a magnetic tape, a hard disk, a read only memory (ROM), an electrically erasable programmable read-only memory (EEPROM (registered trademark)), a flash memory, a random access memory (RAM), an SD (Secure Digital) memory card, or the like.

The above-described program or a part thereof may be recorded on the recording medium so as to be reserved or distributed. In addition, the program may be transmitted by communication, for example, wired networks such as a local area network (LAN), a metropolitan area network (MAN), a wide area network (WAN), the Internet, an intranet, and an extranet, or wireless communication networks. Further, the program may be transmitted using a combination of the transmission media, or may be carried on a carrier.

Further, the above-described program may be a part of another program, or may be recorded on the recording medium along with a separate program. In addition, the program may be recorded on plural recording media so as to be divided. The program may be recorded in any form as long as it can be recovered through compression, encoding, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an image receiving unit that receives an image including an information image which is an image indicating information;
an extraction unit that extracts image identification information for identifying the image and a position in the image from the information image in the image received by the image receiving unit;
a correlation unit that correlates operator identification information for identifying an operator performing an operation with the image identification information and the position in the image extracted by the extraction unit;
an output unit that outputs a result of the correlation by the correlation unit; and
a presentation unit that extracts operator identification information corresponding to the image identification information and the position in the image extracted by the extraction unit from a memory which stores information output by the output unit, and presents a symbol indicating an operator on the image on the basis of the operator identification information.

2. An information processing apparatus comprising:
an image receiving unit that receives an image including an information image which is an image indicating information;
an extraction unit that extracts image identification information for identifying the image and a position in the image from the information image in the image received by the image receiving unit;
a correlation unit that correlates operator identification information for identifying an operator performing an operation with the image identification information and the position in the image extracted by the extraction unit; and
an output unit that outputs a result of the correlation by the correlation unit.

3. The information processing apparatus according to claim 2, wherein the extraction unit extracts a tilt of the information image of the image received by the image receiving unit, and
wherein the correlation unit further correlates the tilt extracted by the extraction unit.

4. The information processing apparatus according to claim 3, wherein the correlation unit further correlates electronic information on the basis of the operation of the operator.

5. An information processing apparatus comprising:
an image receiving unit that receives an image including an information image which is an image indicating information;
an extraction unit that extracts image identification information for identifying the image and a position in the image from the information image in the image received by the image receiving unit; and
a presentation unit that extracts operator identification information corresponding to the image identification information and the position in the image extracted by the extraction unit from a memory which stores operator identification information for identifying an operator in correlation with image identification information and a position in the image, and presents a symbol indicating an operator on the image on the basis of the operator identification information.

6. The information processing apparatus according to claim 5, wherein the memory further stores a tilt of the information image in the image in correlation with image identification information and a position in the image, and
wherein the presentation unit extracts a tilt corresponding to the image identification information and the position in the image extracted by the extraction unit, and presents a symbol indicating the operator so as to be tilted on the basis of the tilt.

7. The information processing apparatus according to claim 5, wherein the memory further stores electronic information in correlation with image identification information and a position in the image, and
wherein the presentation unit extracts electronic information and a tilt corresponding to the image identification information and the position in the image extracted by the extraction unit from the memory, and presents the electronic information so as to be tilted on the basis of the tilt.

8. The information processing apparatus according to claim 6, wherein the memory further stores electronic information in correlation with image identification information and a position in the image, and
wherein the presentation unit extracts electronic information and a tilt corresponding to the image identification information and the position in the image extracted by the extraction unit from the memory, and presents the electronic information so as to be tilted on the basis of the tilt.

9. A non-transitory computer readable medium storing an information processing program causing a computer to function as:
an image receiving unit that receives an image including an information image which is an image indicating information;
an extraction unit that extracts image identification information for identifying the image and a position in the image from the information image in the image received by the image receiving unit;
a correlation unit that correlates operator identification information for identifying an operator performing an operation with the image identification information and the position in the image extracted by the extraction unit;
an output unit that outputs a result of the correlation by the correlation unit; and
a presentation unit that extracts operator identification information corresponding to the image identification information and the position in the image extracted by the extraction unit from a memory which stores information output by the output unit, and presents a symbol indicating an operator on the image on the basis of the operator identification information.

10. A non-transitory computer readable medium storing an information processing program causing a computer to function as:
an image receiving unit that receives an image including an information image which is an image indicating information;
an extraction unit that extracts image identification information for identifying the image and a position in the image from the information image in the image received by the image receiving unit;
a correlation unit that correlates operator identification information for identifying an operator performing an operation with the image identification information and the position in the image extracted by the extraction unit; and
an output unit that outputs a result of the correlation by the correlation unit.

11. A non-transitory computer readable medium storing an information processing program causing a computer to function as:
an image receiving unit that receives an image including an information image which is an image indicating information;
an extraction unit that extracts image identification information for identifying the image and a position in the image from the information image in the image received by the image receiving unit; and
a presentation unit that extracts operator identification information corresponding to the image identification information and the position in the image extracted by the extraction unit from a memory which stores operator identification information for identifying an operator in correlation with image identification information and a position in the image, and presents a symbol indicating an operator on the image on the basis of the operator identification information.

12. An information processing method comprising:
receiving an image including an information image which is an image indicating information;
extracting image identification information for identifying the image and a position in the image from the information image in the received image;
correlating operator identification information for identifying an operator performing an operation with the extracted image identification information and position in the image;
outputting a result of the correlation; and
extracting operator identification information corresponding to the extracted image identification information and position in the image from a memory which stores information, and presenting a symbol indicating an operator on the image on the basis of the operator identification information.

13. An information processing method comprising:
receiving an image including an information image which is an image indicating information;
extracting image identification information for identifying the image and a position in the image from the information image in the received image;
correlating operator identification information for identifying an operator performing an operation with the extracted image identification information and position in the image; and
outputting a result of the correlation.

14. An information processing method comprising:
receiving an image including an information image which is an image indicating information;
extracting image identification information for identifying the image and a position in the image from the information image in the received image; and
extracting operator identification information corresponding to the extracted image identification information and position in the image from a memory which stores operator identification information for identifying an operator in correlation with image identification information and a position in the image, and presenting a symbol indicating an operator on the image on the basis of the operator identification information.
